(19) United States
(12) Patent Application Publication
(10) Pub. No.: US 2003/0122037 A1
(43) Pub. Date: Jul. 3, 2003

(54) Aircraft deicing system

(76) Inventors: Robert William Hyde, Green, OH (US); James Craig Putt, Doylestown, OH (US); Michael Milton Kugelman, Akron, OH (US); Steven Charles Brooker, Hartville, OH (US)

Correspondence Address: Cynthia S. Murphy, Renner, Otto, Boisselle & Sklar, LLP, Nineteenth Floor, 1621 Euclid Avenue, Cleveland, OH, 44115-2191, US

(21) Appl. No.: 10/315,753

(22) Filed: Dec. 6, 2002

Related U.S. Application Data
(60) Provisional application No. 60/337,083, filed on Dec. 6, 2001.

(51) Int. Cl. B64D 15/00

(52) U.S. Cl. 244/134 A

(57) ABSTRACT

A deicing system (10) for preventing ice accumulation on an airfoil surface (14) of an aircraft (12). The system (10) can comprise a control module (66) which controls a valve (64) based on a pressure conditions within the deicer chambers (30), a reservoir (60) for providing pressurized inflation fluid to the deicer chambers (30), and/or a line (62) for providing the deflation suction for the airfoil's low-pressure side (18).

### RELATED APPLICATIONS

This application claims priority under 35 U.S.C. §119(e) to U.S. Provisional Patent Application No. 60/337,083 filed on Dec. 6, 2001. The entire disclosure is this earlier application is hereby incorporated by reference.

### FIELD OF THE INVENTION

This invention relates generally as indicated to an aircraft deicing system and, more particularly, to a pneumatic deicing system wherein inflatable passages are inflated and deflated to remove ice accumulation from an airfoil surface.

### BACKGROUND OF THE INVENTION

An aircraft may be exposed periodically to conditions of precipitation and low temperatures which may cause the formation of ice on the leading edges of its wings and/or on other airfoils during flight. If the aircraft is to perform adequately in flight, it is important that this ice be removed. To this end, various types of aircraft deicers have been developed to address the ice-accumulation issue. An aircraft deicer is designed to break up undesirable ice accumulations which tend to form on certain airfoils (such as the leading edges of the aircraft's wings) when the aircraft is operating in severe climatic conditions.

Of particular interest to the present invention is a pneumatic aircraft deicer. A pneumatic deicer typically comprises a deicing panel that is installed on the surface to be protected, such as the leading edge of an aircraft wing. An inflation fluid is repeatedly alternately introduced into and evacuated from inflatable chambers in the panel during operation of the deicer. The cyclic inflation and deflation of the chambers cause a change in the surface geometry and surface area, thereby imposing shear stresses and fracture stresses upon the sheet of ice. The shear stresses displace the boundary layer of the sheet of ice from the deicer's breezeside surface and the fracture stresses break the ice sheet into small pieces, which may be swept away by the airstream that passes over the aircraft wing.

Accordingly, a pneumatic deicing system requires a source of pressurized inflation fluid and a device for opening/closing passageways between the inflation fluid source and the deicer's inflation chambers. Specifically, the flow-controlling device must initiate the flow of inflation fluid into the chambers and terminate this flow at the appropriate time. To initiate the flow, an “inflate” signal is provided either manually or automatically to the flow-controlling device upon ice accumulation. To terminate the flow, electronic timers are used to cease flow after an appropriate time period and thereby control the volume of flow of the inflation fluid.

Inflation fluid for deicer chambers traditionally has been provided by an external source of pressure, such as an on-board engine-driven pump (e.g., in an piston engine aircraft) and/or from extracted engine bleed air (e.g., in a turbo-prop or turbo-jet aircraft). Also, an aircraft deicing system may require that a vacuum be applied to maintain the deicer chambers during deflation and/or to maintain deflation under negative aerodynamic pressures. In a pump system, the deflation vacuum can be obtained from the vacuum side of the pump. In a bleed air driven system, an ejector or venturi can be used to generate a vacuum from the available pressure.

### SUMMARY OF THE INVENTION

The present invention provides a pneumatic deicing system wherein pressure is used to control the volume of flow of the inflation fluid to the deicer chambers, wherein pressure regulation between the source of inflation fluid and the deicer are not necessary, wherein an external source of pressure is not required, and/or wherein deflation suction is provided by already existent aerodynamic conditions.

More particularly, the present invention provides a deicing system for the prevention of ice accumulation on an airfoil surface of an aircraft, this system comprising a panel having a bondside surface adapted for attachment to the airfoil surface, a breezeside surface on which ice will accumulate during operation of the aircraft, and surfaces therebetween defining inflatable deicer chambers. A valve routes pressurized inflation fluid from a suitable source to the deicer chambers to inflate the chambers.

According to one embodiment of the invention, the deicing system can include a pressure-sensing device, which senses when the deicer chambers have reached a predetermined effective inflation pressure. For example, the pressure-sensing device comprises a normally-closed switch, which opens when the deicer chambers reach the effective inflation pressure. The pressure-sensing device can be mounted on a connection line between the reservoir and the deicer chambers. In any event, the electronic timers normally used to control inflation intervals can be eliminated from the system's architecture. Also, changes in inflation pressure as provided from the source become irrelevant when pressure, rather than time, is used to control inflation intervals, whereby pressure regulators can also be eliminated from the system's architecture.

The valve can be switchable between an inflation mode, whereat it routes the pressurized inflation fluid from the reservoir to deicer chambers to inflate the chambers, and a deflation mode. For example, the valve can be a solenoid valve movable between an energized position (e.g., corresponding to the inflation mode) and a de-energized position (e.g., corresponding to the deflation mode). The valve can be designed to draw a minimum amount of power (e.g., less than about 3 amp, less than about 2 amp, and/or less than about 1 amp) when in its energized position. A controller, such as a latching circuit, can be used to switch the valve to inflation mode upon receipt of an appropriate inflate signal which can be, for example, a momentary normally-off switch. To maintain independence from the rest of the aircraft, the controller can be powered by a battery.

According to another embodiment of the invention, the source of inflation fluid can be a reservoir charged with a suitable pressurized fluid (e.g., air, nitrogen, and/or a mixture of nitrogen and carbon dioxide), whereby the valve will route the pressurized inflation fluid from the reservoir to the deicer chambers to inflate the chambers. As inflation fluid is supplied to the deicer chambers, the pressure of the inflation fluid will drop from a maximum starting pressure (e.g., at least about 500 psig, at least about 1000 psig, at least about 2000 psig and/or at least about 3000 psig) to a useable minimum pressure (e.g., at least about 150 psig). By using the reservoir as the source of inflation fluid, external sources, such as an on-board engine-driven pump or extracted engine bleed air, are not needed. Also, the system's architecture no longer requires regulators to regulate the pressure of the inflation fluid, pre-coolers to thermally adjust the temperature of the inflation fluid, and/or check valves to ensure the correct path of the inflation fluid.

The reservoir and the valve can be a part of a reservoir assembly which also includes a controller which controls the valve. The valve and the controller can be incorporated into an adapter header for the reservoir, whereby high pressure lines therebetween are not required. The header can also include components to accommodate pre-flight filling of the reservoir such as, for example, a fitting for charging the reservoir, a pressure gauge for verifying reservoir pressure before dispatch, and/or a relief valve for preventing over-pressurization.

According to a further embodiment of the invention, the deflation vacuum can be provided by a suction line extending from a suction side of the airfoil surface to the deicer chambers. For example, if the airfoil surface is the wing of the aircraft, the suction line can extend from a flush-mounted port on the top side of the wing. In any event, deflation suction is provided by already existing aerodynamic conditions and need not be generated elsewhere in the aircraft.

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIG. 1 is a perspective view of a deicer according the present invention, the deicer being shown secured to the leading edge of an aircraft wing.

FIG. 2 is an enlarged perspective view of one wing of the aircraft and a deicer panel, with certain parts broken away for clarity in explanation.

FIGS. 3A and 3B are sectional views of the deicer panel in a deflated state and an inflated state, respectively.

FIG. 4 is a schematic diagram of the aircraft wing, the deicer panel, and other deicer components, which selectively inflate and deflate the panel.

FIG. 5 is an electrical schematic diagram of electrical circuitry that can be used to control the selective inflation and deflation of the panel.

FIG. 6 is a schematic diagram similar to FIG. 4 except that a suction line is not provided for deflation of the panel.

FIG. 7 is a schematic diagram similar to FIG. 4 except that the deflation fluid is provided from an aircraft source.

FIG. 8 is a schematic diagram similar to FIG. 4 except that the inflation fluid is provided from an aircraft source.

### DETAILED DESCRIPTION

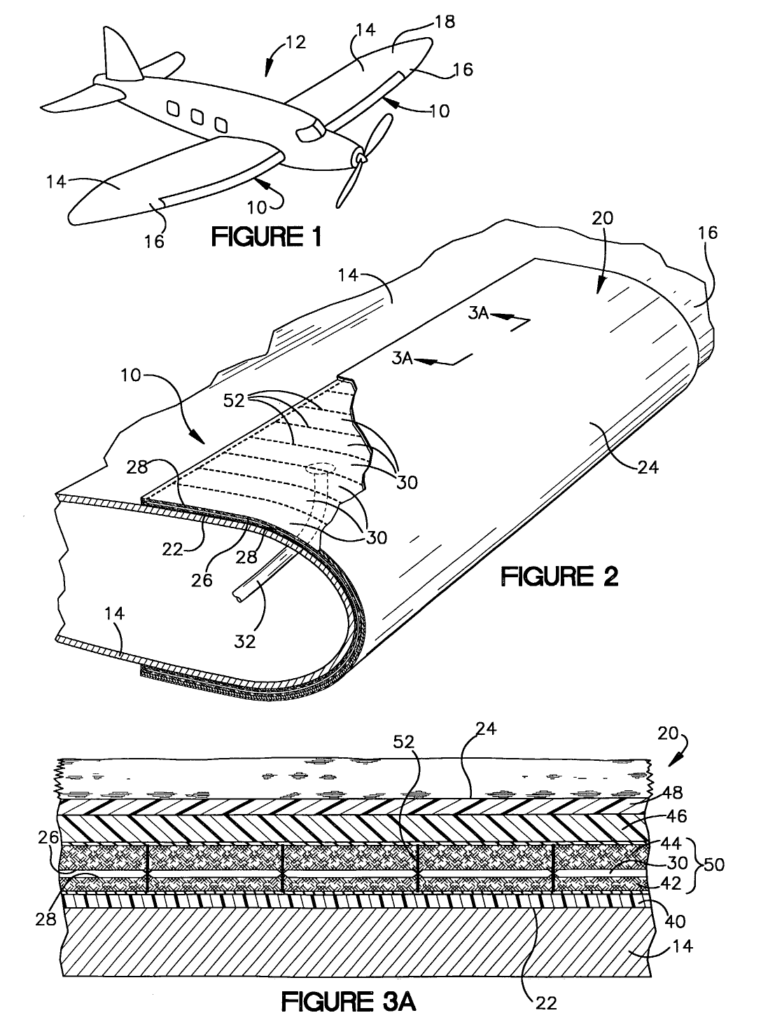

Referring now to the drawings, and initially to FIG. 1, a deicing system 10 according to the present invention is shown installed on an aircraft 12. More particularly, the deicing system 10 is shown installed on each of the leading edges 16 of the wings 14 of the aircraft 12. The system 10 breaks up undesirable ice accumulations which tend to form on the leading edges 16 of the aircraft wings 14 under severe climatic flying conditions. The wings 14 each have an airfoil geometry, wherein the pressure just above the top side 18 of the wing 14 is lower than the pressure below the wing 14, thereby creating lift forces.

Referring additionally to FIG. 2, it can be seen that the deicing system includes a deicing panel 20 that is installed on the surface to be protected which, in the illustrated embodiment, is the leading edge 16 of the wing 14. One surface of the deicing panel 20, the bondside surface 22, is adhesively bonded to the wing 14. The other surface of the deicing panel 20, the breezeside surface 24, is exposed to the atmosphere. During operation of the aircraft 12 in severe climate conditions, atmospheric ice will accumulate on the deicer's breezeside surface 24. The panel 20 also includes inner surfaces 26 and 28, which define inflatable chambers 30. An inflation fluid (e.g., air) is introduced and evacuated from the chambers 30 via a suitable connection line 32. In the illustrated embodiment, each of the inflatable chambers 30 has a tube-like shape extending in a curved path parallel or perpendicular to the leading edge of the aircraft wing 14. The illustrated inflatable chambers 30 are arranged in a spanwise succession and are spaced in a chordwise manner, but may be in a chordwise succession spaced in a spanwise manner.

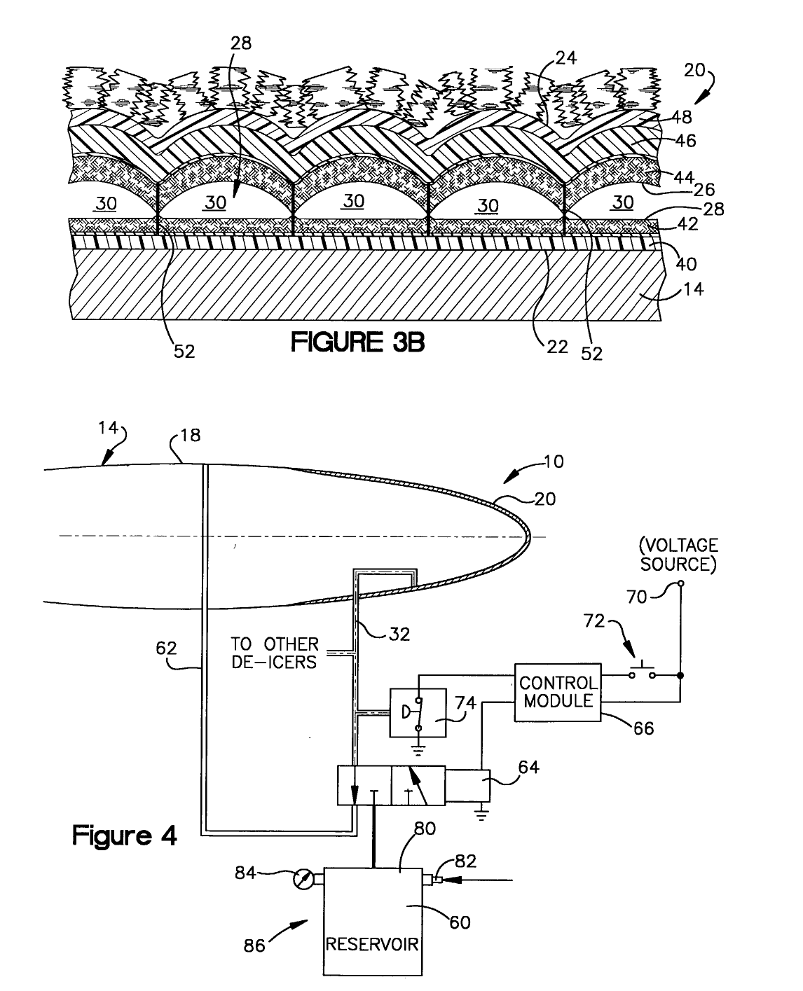

Referring further to FIGS. 3A and 3B, the chambers 30 are shown in a deflated state and an inflated state, respectively. When the chambers 30 are in a deflated state, the breezeside surface 24 of the deicer panel 20 has a smooth profile conforming to the desired airfoil shape, and ice accumulates thereon in a sheet-like form. Also, the passage-defining surfaces 26 and 28 are positioned flush and parallel with each other and may contact each other. (FIG. 3A.) When the chambers 30 are in an inflated state, the breezeside surface 24 and the passage-defining surface 28 take on a bumpy profile with a series of parabolic-shaped hills corresponding to the placement of the chambers 30. (FIG. 3B.)

The change of surface geometry and surface area that results from the inflation/deflation of the chambers 30 imposes shear stresses and fracture stresses upon the sheet of ice. The shear stresses displace the sheet of ice from the deicer's breezeside surface 24 and the fracture stresses break the ice sheet into small pieces, which may be swept away by the airstream passing over the aircraft wing 14 during flight. (FIG. 3B.)

The deicer panel 20 is formed from a plurality of layers or plies 40, 42, 44, 46, and 48. The layer 40 is positioned closest to the aircraft wing 14 and its wing-adjacent surface forms the bondside surface 22 of the deicer panel 20. The layer 42 is positioned adjacent to the layer 40 and the layer 44 is positioned adjacent to the layer 42. The facing surfaces of the layers 42 and 44 define the passage-defining surfaces 26 and 28, respectively, of the deicer panel 20. The layer 46 is positioned adjacent to the layer 44. The layer 48 is positioned adjacent to the layer 46 and is farthest from the aircraft wing 14, whereby its exposed surface forms the breezeside surface 24 of the deicer panel 20. During inflation/deflation of the chambers 30, the layers 40 and 42 maintain substantially the same smooth shape while the layers 44, 46, and 48 transform between a smooth shape and the bumpy profile shown in FIG. 3B.

The non-deformable layer 40 provides a suitable bondside surface 22 for attachment to the aircraft wing 14, and the deformable layer 46 is provided to facilitate the return of the other deformable layers 44 and 48 to the flush deflated position. The layers 42 and 44 are commonly viewed as the carcass 50 of the deicer 10 and/or the deicer panel 20, and are typically sewn together with stitches 52 to establish the desired inflation chambers 30. Securement of the various deicer layers together and to the leading edge of the aircraft may be accomplished by cements, pressure-sensitive adhesives, or other bonding agents compatible with the materials employed.

Referring now to FIG. 4, the components for inflating/deflating the deicer chambers 30 are schematically shown. These components include a reservoir 60 that supplies inflation pressure, a suction line 62 that supplies deflation vacuum, a valve 64 for routing the flow of fluid into or out of the chambers 30, and a control module 66 for controlling the valve 64.

The reservoir 60 is charged with a pressured fluid, such as air, nitrogen, a mixture of nitrogen and carbon dioxide (e.g., 70% nitrogen, 30% carbon dioxide), and/or any other suitable fluid. The reservoir 60 can be a DOT-approved and qualified vessel having an aluminum liner with an aramid or carbon-fiber overwrap for minimum weight. (Reservoirs of this type have been certified for use on commercial aircraft emergency evacuation systems.) Operating pressure for the reservoir 60 can be, for example, about 3000 psig at its maximum and can drop to about 150 psig. The size of the reservoir 60 is based on the size and number of the deicer chambers 30 and the number of deicing cycles expected during a given flight or series of flights.

The suction line 62 extends from a flush-mounted port on the top side 18 of the aircraft wing 14. Accordingly, the line 62 extends from a low pressure location, and preferably a maximum suction location. Quarter-inch diameter tubing (0.25 inch OD), such as aluminum tubing, can be suitable for conveying the vacuum (as well as pressurized fluid) to the chambers 30.

The valve 64 can be a three-way, two-position piloted or non-piloted solenoid valve switchable between an inflation mode and a deflation mode. In the illustrated embodiment, the valve 64 forms a passageway between the reservoir 60 and the deicer line 32 when in an energized inflating condition, and forms a passageway between the deicer line 32 and the suction line 62 when in a de-energized deflating condition. It may be noted that the valve 64 can be designed so that, in its energized condition, it draws about 1 amp maximum at 28 VDC.

The control module 66 controls the valve 64 to switch it between the energized and de-energized conditions. The module 66 can be a latching circuit (e.g., a solid state latching circuit) powered by an electrical voltage source 70, such as a battery or the aircraft's electrical system. Upon input of an appropriate “inflate” signal, the module 66 switches the valve 64 to its inflating position and pressurized fluid from the reservoir 60 is routed to the inflation chambers 30. Upon the chambers 30 reaching a predetermined effective inflation pressure, the module 66 switches the valve 64 to its deflating position, thereby connecting the chambers 30 to the suction line 62. The module 66 consumes no electrical power when the deicer chambers 30 are not being inflated, and only a few milliamps during the few seconds that the valve 64 is energized.

The “inflate”0 signal can be provided by a momentary normally-off switch 72, which is activated either automatically or manually upon ice accumulation. A pressure-sensing device 74 can be used to sense when the deicer chambers 30 reach the desired pressure and to convey this information to the control module. For example, the device 74 can comprise a normally-closed switch which opens upon reaching a predetermined effective inflation pressure. Alternatively, the device 74 can comprise a normally-open switch which closes upon reaching a predetermined effective inflation pressure. It may be noted that using pressure, rather than another variable such as time, eliminates the need for inflation fluid to be provided at a constant and/or known pressure.

An adaptor header 80 can be installed on the reservoir 60 (e.g., threaded onto its outlet port) to accommodate pre-flight charging procedures. For example, the header 80 can include a fitting 82 for charging the reservoir 60, a pressure gauge 84 for verifying reservoir pressure before dispatch, and a relief valve (not shown) for preventing over-pressurization. The header 80 can also incorporate the valve 64 and the control module 66 and, if so, high pressure lines are unnecessary for connections between these components and reservoir 60.

If the adapter header 80 is provided, the reservoir 60 and the header 80 can be viewed as together forming a reservoir assembly 86. The connection line 32 from the reservoir assembly 86 to the deicer chambers 30 can be smaller than that required for conventional pneumatic deicing systems, as the supply pressure is not regulated. In any event, the line 32 may be equipped with quick-disconnect fittings for detachable wings.

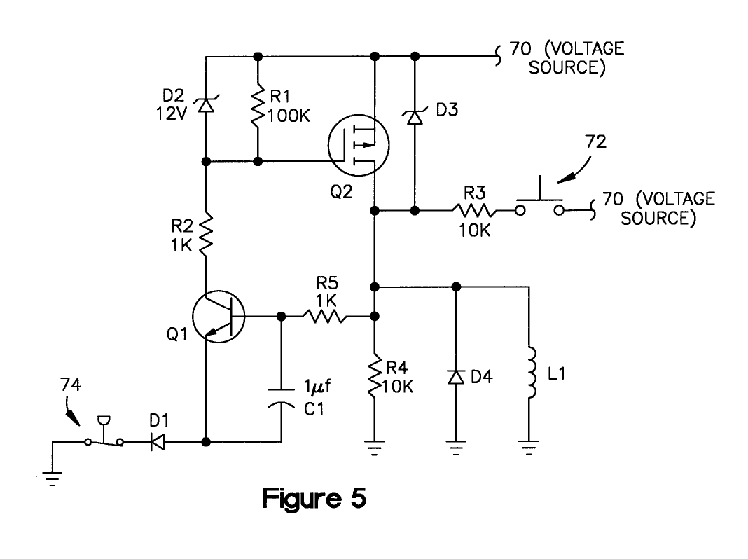

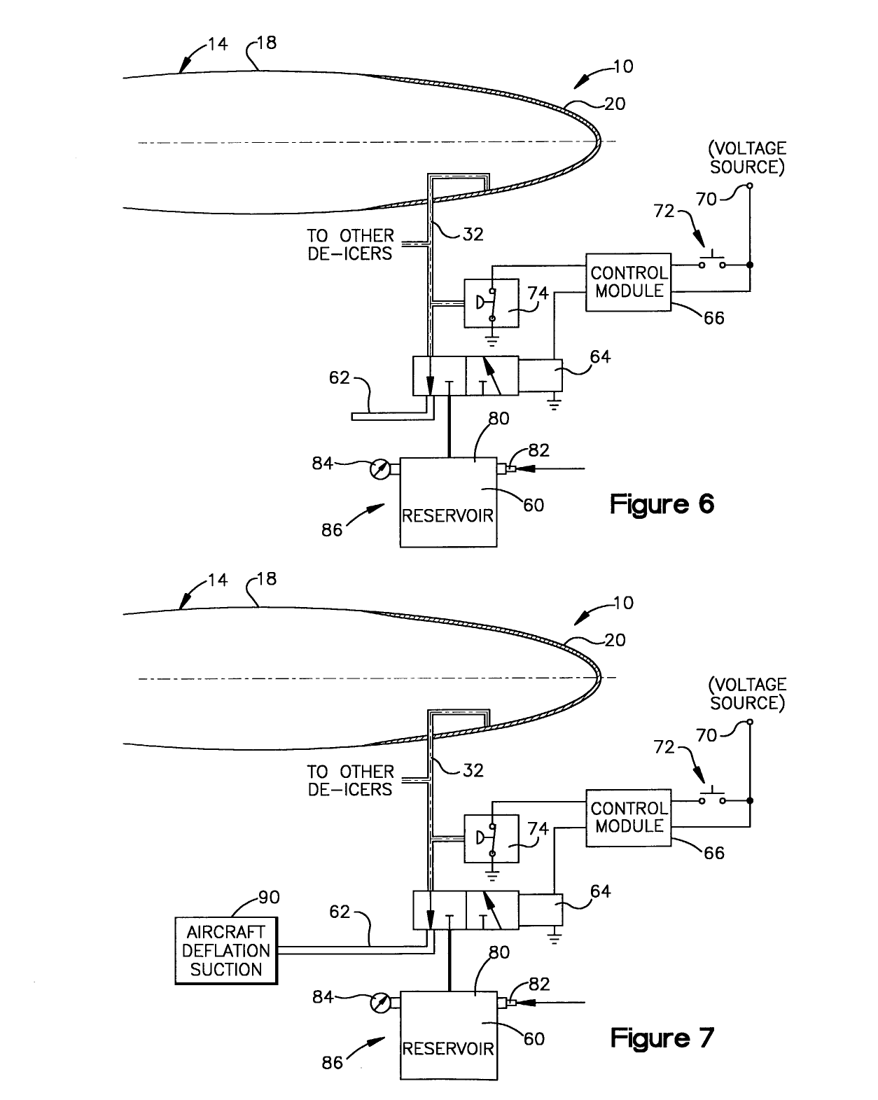

Electrical circuitry that can be used to control the selective inflation and deflation of the panel 20 is shown in FIG. 5. The illustrated circuitry includes the momentary input switch 72, the pressure switch 74, solenoid coil L1 (part of the valve 64), transistors Q1 and Q2, resistors R1-R5, capacitor C1 and diodes D1-D4. In this embodiment, the pressure switch 74 is normally closed and opens upon the reaching of a predetermined effective inflation pressure. When power is off (i.e., no voltage is being provided by the source 70), the circuit is inactive and no power is delivered to the solenoid coil L1.

When the power is on (i.e., voltage is being provided by the source 70), power is delivered to the solenoid coil L1 only upon energization of the momentary input switch 72 and continues only until the normally-closed pressure switch 74 opens. Prior to closing of the switch 72, there is no drive to the base of bipolar transistor Q1, whereby transistor Q2 (a p-channel FET) is not turned on and solenoid coil L1 is not energized. When the switch 72 is closed, transistor Q1 is momentarily driven on via R5, R3, D1 and (closed) pressure switch 74. When Q1 is turned on, it turns on Q2 via R2 and D2. Q2 energizes the solenoid coil L1 to move the valve 64 to its inflating position. Q2 also latches the circuit by supplying Q1 with base current keeping Q1 on. C1 provides a small delay to prevent noise from latching the circuit on, D4 provides fly-back protection from the kick of the solenoid coil L1 being de-energized, R1 and R4 provide pull down resistors for Q1 and Q2, D2 provides gate protection for Q2, and D3 provides spike protection for Q2.

The circuit stays in this state (i.e., pressurized fluid is supplied to the inflation chambers 30) until the pressure switch 74 opens (i.e., when predetermined effective inflation pressure is reached). The opening of the switch 74 turns Q1 and Q2 off, thereby de-latching the circuit and removing power to the solenoid coil L1 so that the valve 64 is moved to its non-inflating position. The circuit remains in this condition until the momentary input switch 72 is again closed.

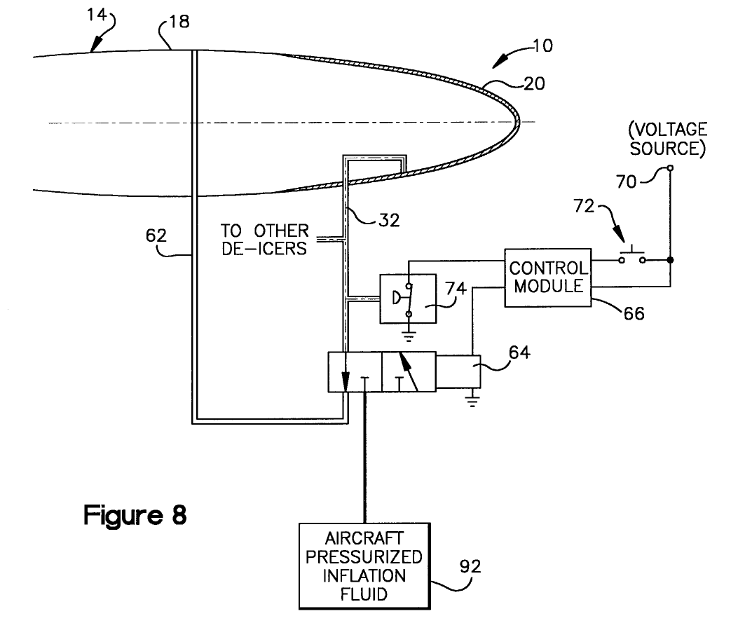

In the embodiment shown in FIG. 4, inflation fluid is provided from the self-contained reservoir 60 and deflation suction is provided from the low pressure side 18 of the airfoil 14. However, in many aircraft, suction is not necessary to deflate and/or maintain deflation of the deicer chambers 30 whereby the suction line 62 can exhaust to the atmosphere immediately following an inflation cycle, and remains in connection with the atmosphere until the next inflation cycle begins. Alternatively, as shown in FIG. 7, deflation suction can be provided from external aircraft source 90, such as the vacuum side of a pump or from an ejector or venturi. Additionally or alternatively, as shown in FIG. 8, the inflation fluid can be provided from an aircraft-generated source 92 such as an electrical or mechanical pump, a compressor, and/or extracted engine bleed air.

The control device 66 and/or the pressure-sensing device 84 can be used in an aircraft deicing system without deflation suction, with deflation suction generated by an external aircraft source, and/or with inflation fluid supplied from an external aircraft source. Also, the self-contained reservoir 60 can be used in an aircraft deicing system without deflation suction or with deflation suction being generated by an external aircraft source.

One may now appreciate that the present invention provides a deicing system 10 wherein pressure is used to control the volume of flow of the inflation fluid to the deicer chambers, wherein pressure regulation between the source of inflation fluid and the deicer is not necessary, wherein an external source of pressure is not required, and/or wherein deflation suction is provided by already existing aerodynamic conditions. Although the invention has been shown and described with respect to a certain preferred embodiment, it is evident that equivalent and obvious alterations and modifications will occur to others skilled in the art upon the reading and understanding of this specification. The present invention includes all such alterations and modifications and is limited only by the scope of the following claims.

1. A deicing system for prevention of ice accumulation on an airfoil surface of an aircraft, said system comprising:
a panel having a bondside surface adapted for attachment to the airfoil surface, a breezeside surface upon which ice will accumulate during operation of the aircraft, and surfaces therebetween defining inflatable deicer chambers;
a source of pressurized inflation fluid;
a control device which routes the pressurized inflation fluid to the deicer chambers to inflate the chambers until they reach a predetermined effective inflation pressure; and
a pressure-sensing device which senses when the deicer chambers have reached the predetermined effective inflation pressure.

2. A deicing system as set forth in claim 1, wherein the pressure-sensing device comprises a normally-closed switch which opens upon the deicer chambers reaching the effective inflation pressure.

3. A deicing system as set forth in claim 1, wherein the control device comprises a valve which forms a path between the deicer chambers and a suction line when in a deflation mode.

4. A deicing system as set forth in claim 3, wherein the suction line extends from a suction side of the airfoil surface.

5. A deicing system as set forth in claim 4, wherein the suction line extends from a maximum suction location on the suction side of the airfoil surface.

6. A deicing system as set forth in claim 4, wherein the suction line extends from a flush-mounted port on the top side of the airfoil surface.

7. A deicing system as set forth in claim 3, wherein the valve forms a path between the deicer chambers and an exhaust port open to ambient air when in its deflation mode.

8. A deicing system as set forth in claim 3, wherein the valve forms a path between the deicer chambers and a line to an external aircraft source of deflation suction when in its deflation mode.

9. A deicing system as set forth in claim 3, wherein the control device comprises a controller which controls the valve to switch it between an inflation mode and the deflation mode.

10. A deicing system as set forth in claim 9, wherein the controller comprises a latching circuit.

11. A deicing system as set forth in claim 9, wherein the controller switches the valve to its inflation mode upon input of an appropriate inflate signal.

12. A deicing system as set forth in claim 11, wherein the inflate signal is provided by a momentary normally-off switch.

13. A deicing system as set forth in claim 1, wherein the source of pressurized inflation fluid comprises a reservoir containing pressurized inflation fluid.

14. A deicing system as set forth in claim 13, wherein the pressure of the inflation fluid in the reservoir drops during operation from a maximum starting pressure to a minimum useable pressure, wherein the maximum starting pressure is about at least 500 psig and wherein the minimum useable pressure is at least 150 psig.

15. A deicing system as set forth in claim 13, wherein the inflation fluid comprises air, nitrogen, a mixture of nitrogen and carbon dioxide, and/or other suitable gases.

16. A deicing system as set forth in claim 3, wherein the valve is a solenoid valve movable between an energized position and a de-energized position.

17. A deicing system as set forth in claim 16, wherein the valve is in an energized position in the inflation mode and in a de-energized position in the deflation mode.

18. A deicing system for prevention of ice accumulation on an airfoil surface of an aircraft, said system comprising:
a panel having a bondside surface adapted for attachment to the airfoil surface, a breezeside surface upon which ice will accumulate during operation of the aircraft, and surfaces therebetween defining inflatable deicer chambers;
a reservoir containing pressurized inflation fluid; and
a valve which routes the pressurized inflation fluid from the reservoir to the deicer chambers to inflate the chambers.

19. A deicing system as set forth in claim 18, wherein the pressure of the inflation fluid in the reservoir drops during operation from a maximum starting pressure to a minimum useable pressure.

20. A deicing system as set forth in claim 19, wherein the maximum starting pressure is about at least 500 psig.

21. A deicing system as set forth in claim 20, wherein the maximum starting pressure is about at least 1000 psig.

22. A deicing system as set forth in the claim 21, wherein the maximum starting pressure is about at least 2000 psig.

23. A deicing system as set forth in the claim 22, wherein the maximum starting pressure is about at least 3000 psig.

24. A deicing system as set forth in claim 18, wherein the minimum useable pressure is at least 150 psig.

25. A deicing system as set forth in claim 18, wherein inflation fluid comprises air, nitrogen, a mixture of nitrogen and carbon dioxide, and/or other suitable gases.

26. A deicing system as set forth in claim 17, wherein the valve is switchable between an inflation mode, whereat it routes the pressurized inflation fluid from the reservoir to deicer chambers to inflate the chambers, and a deflation mode.

27. A deicing system as set forth in claim 18, wherein the valve is a solenoid valve movable between an energized position and a de-energized position.

28. A deicing system as set forth in claim 18, wherein the valve is in an energized position in the inflation mode and in a de-energized position in the deflation mode.

29. A deicing system as set forth in claim 28, wherein the valve consumes no electric power in its deflation mode.

30. A deicing system as set forth in claim 29, wherein the valve draws less than about 3 amp maximum when in its energized position.

31. A deicing system as set forth in claim 30, wherein the valve draws less than about 2 amp maximum when in its energized position.

32. A deicing system as set forth in claim 31, wherein the valve draws less than about 1 amp maximum when in its energized position.

33. A deicing system as set forth in claim 18, wherein an adapter header is installed on the reservoir.

34. A deicing system as set forth in claim 33, wherein the adapter header includes a fitting for charging the reservoir, a pressure gauge for verifying reservoir pressure before dispatch, and/or a relief valve for preventing over-pressurization.

35. A deicing system as set forth in claim 33, wherein the header incorporates the valve.

36. A deicing system as set forth in claim 35, wherein the header also incorporates a controller which controls the valve to switch it between the inflation mode and the deflation mode.

37. A deicing system for prevention of ice accumulation on an airfoil surface of an aircraft, said system comprising:
a panel having a bondside surface adapted for attachment to the airfoil surface, a breezeside surface upon which ice will accumulate during operation of the aircraft, and surfaces therebetween defining inflatable deicer chambers;
a source of pressurized inflation fluid to inflate deicer chambers; and
a suction line extending from a suction side of the airfoil surface to the deicer chambers to provide deflation suction to deflate the deicer chambers.

38. A deicing system as set forth in claim 37, wherein the suction line extends from a maximum suction location on the suction side of the airfoil surface.

39. A deicing system as set forth in claim 37, wherein the suction line extends from a flush-mounted port on the top side of the airfoil surface.

40. A deicing system for prevention of ice accumulation on an airfoil surface of an aircraft, said system comprising:
a panel having a bondside surface adapted for attachment to the airfoil surface, a breezeside surface upon which ice will accumulate during operation of the aircraft, and surfaces therebetween defining inflatable deicer chambers; and
a reservoir assembly including a reservoir containing pressurized inflation fluid, a valve which routes the pressurized inflation fluid from the reservoir to the deicer chambers to inflate the chambers, and a controller which controls the valve.

41. A deicing system as set forth in claim 40, wherein the reservoir assembly includes an adapter header for the reservoir, and wherein the header incorporates the valve and the controller.

42. A deicing system as set forth in claim 40, wherein the header includes a fitting for charging the reservoir, a pressure gauge for verifying reservoir pressure before dispatch, and/or a relief valve for preventing over-pressurization.

43. In combination, an aircraft and the deicing system set forth in claim 1 installed on an airfoil surface of the aircraft.

44. The combination set forth in claim 43, wherein the airfoil surface is a wing of the aircraft.

45. In combination, an aircraft and the deicing system set forth in claim 18 installed on an airfoil surface of the aircraft.

46. The combination set forth in claim 45, wherein the airfoil surface is a wing of the aircraft.

47. In combination, an aircraft and the deicing system set forth in claim 37 installed on an airfoil surface of the aircraft.

48. The combination set forth in claim 47, wherein the airfoil surface is a wing of the aircraft.

49. A method of preventing ice accumulation on an airfoil surface of an aircraft, comprising the steps of:
installing the deicing system set forth in claim 1 on the aircraft; and
routing the pressurized inflation fluid to the deicer chambers to inflate the deicer chambers.

50. A method of preventing ice accumulation on an airfoil surface of an aircraft, comprising the steps of:
installing the deicing system set forth in claim 18 on the aircraft; and
controlling the valve to route the pressurized inflation fluid to the deicer chambers to inflate the deicer chambers.

51. A method of preventing ice accumulation on an airfoil surface of an aircraft, comprising the steps of:
installing the deicing system set forth in claim 37 on the aircraft; and
inflating the deicer inflation chambers.
